(19) United States
(12) Patent Application Publication
(10) Pub. No.: US 2008/0237507 A1
(43) Pub. Date: Oct. 2, 2008

(54) RADIATION IMAGE RECORDING SYSTEM

(75) Inventor: Jun ENOMOTO, Ashigara-kami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/056,847

(22) Filed: Mar. 27, 2008

(30) Foreign Application Priority Data
Mar. 27, 2007 (JP) 2007-081305

(51) Int. Cl. G01N 23/04

(52) U.S. Cl. 250/582

(57) ABSTRACT

The radiation image recording system includes a radiation source irradiating a subject with radiation to record a subject's radiation image; a solid-state radiation detector detecting the radiation from the radiation source; a memory storing calibration information of the radiation image detected by the solid-state radiation detector; an image processor subjecting recorded data of the radiation image to image corrections based on the calibration information; stabilizing time monitor checking time elapsed since start of power application to the radiation detector; and a controller setting a recording mode of the radiation image based on information on the elapsed time. When the information on the elapsed time indicates that a specified stabilizing time has elapsed, the controller causes the radiation detector to undergo a calibration to acquire new calibration information and causes the memory to store the acquired new calibration information to which the stored calibration information is updated.

The entire contents of documents cited in this specification are incorporated herein by reference.

### BACKGROUND OF THE INVENTION

The present invention relates to a radiation image recording system that involves a radiation image recording apparatus using a solid-state radiation detector and, more particularly, to a radiation image recording system that is suitable for typical use in emergency medical centers (hereinafter referred to simply as medical centers) admitting emergency patients (hereinafter referred to as emergencies) and which is furnished with capabilities for dealing with such emergencies in an advantageous way.

In applications such as medical diagnostic imaging and industrial non-destructive testing, there is conventionally used a radiation image detector which records a radiation image by first allowing a radiation (e.g. X-rays, α-rays, β-rays, γ-rays, electron beams or uv rays) to pass through an object and then picking up the radiation as an electrical signal.

Examples of this radiation image detector are a solid-state radiation detector (so-called “flat panel detector” which is hereinafter sometimes referred to as “FPD”) that picks up the radiation as an electrical image signal and an X-ray image tube that picks up a radiation image as a visible one.

FPDs are operated by one of two methods, direct and indirect; in the direct method, electron-hole pairs (e-h pairs) emitted from a film of photoconductive material such as amorphous selenium upon incidence of a radiation are collected and read as an electrical signal, whereby the radiation is “directly” converted to the electrical signal; in the indirect method, a phosphor layer (scintillator layer) which is formed of a phosphor that emits light (fluorescence) upon incidence of a radiation is provided such that it converts the radiation to visible light, which is read with a photoelectric transducer, whereby the radiation “as visible light” is converted to an electrical signal.

Radiation detectors typified by the FPD require a certain period of time before it reaches a stable state after a specified high-voltage power supply is turned on. In addition, after the stable state is reached, the radiation image recording apparatus (hereinafter referred to simply as the imaging apparatus) has to undergo calibration as an imaging apparatus.

Thus, in order to cope with an unexpected trouble with the power supply such as power failure, imaging apparatuses that use the radiation detector under consideration are customarily connected to an uninterruptible power supply (UPS), as disclosed in JP 2005-118348 A and JP 2005-109751 A; if the power failure lasts for only a short period of time, the system can resume operation shortly after power recovery.

Further, it is known that the life factor of an FPD due to deterioration from prolonged application of an electric current is not negligible and that it is important to use the FPD efficiently to avoid unnecessary current application.

Further in addition, the FPD is such an expensive device that frequent replacement is infeasible.

### SUMMARY OF THE INVENTION

However, if the power failure is long enough to exceed the capacity of the battery in the uninterruptible power supply (UPS) or once power is down at the end of the day's work, it takes time for the radiation detector to be stabilized once again; if there is an unexpected call for diagnosis as from an emergency, it has been difficult for the system to cope with the situation.

People working at medical centers and the like have not keenly felt this problem and, as a matter of fact, no proposal has been made to solve it.

The present invention has been accomplished under these circumstances and has as an object providing a radiation image recording system that uses an imaging apparatus that takes into account the service life of a solid-state radiation detector (FPD) and which yet can cope with emergencies in an advantageous way.

More specifically, it is an object of the present invention to provide a novel radiation image recording system that involves an imaging apparatus using a solid-state radiation detector (FPD) and which is adapted to be capable of coping with emergencies in a special mode.

In order to attain these objects, the present invention provides a radiation image recording system comprising:

a radiation source which irradiates a subject with radiation to record a radiation image of the subject;

a solid-state radiation detector which detects the radiation emitted from the radiation source;

information storage means which stores calibration information of the radiation image detected by the solid-state radiation detector;

image processing means which subjects recorded data of the radiation image of the subject as detected by the solid-state radiation detector to image corrections based on the calibration information stored in the information storage means;

stabilizing time monitor means which monitors time elapsed since start of power application to the solid-state radiation detector; and

control means which sets a recording mode of the radiation image of the subject based on information on the elapsed time as obtained from the stabilizing time monitor means,

wherein, when the information on the elapsed time indicates that a specified stabilizing time has elapsed, the control means causes the solid-state radiation detector to undergo a calibration to acquire new calibration information and causes the information storage means to store the acquired new calibration information to update the stored calibration information to the new calibration information.

Preferably, the control means further confirms a status of the calibration information stored in the information storage means based on the recording mode.

Preferably, the control means further causes the image processing means to perform the image corrections on the recorded data based on the calibration information stored in the information storage means in accordance with the recording mode being set and the confirmed status of the calibration information.

Preferably, the control means further determines whether or not the calibration information stored in the information storage means is to be updated, and when the calibration information is determined to be updated, the control means causes the calibration to be executed to acquire the new calibration information to be stored in the information storage means as the calibration information, and causes the image processing means to perform the image corrections on the recorded data based on the acquired new calibration information after the recorded data has been acquired or while the recorded data is being acquired beforehand.

Preferably, the radiation image recording system has the recording mode selected from an emergency mode that corresponds to a case where the solid-state radiation detector is not in a stable state and a normal mode that corresponds to a case where the solid-state radiation detector is in a stable state, and the control means sets the emergency mode as the recording mode when the information on the elapsed time from the stabilizing time monitor means is information indicating that the specified stabilizing time necessary to bring the solid-state radiation detector into the stable state has not elapsed, and sets the normal mode as the recording mode when the information on the elapsed time is information indicating that the specified stabilizing time has elapsed.

Preferably, the control means enables the radiation image of the subject to be recorded in the emergency mode without causing the calibration to be executed.

Preferably, the radiation image of the subject to be output is tagged with information to effect that the radiation image is an image recorded in the emergency mode which is not subjected to the image corrections based on the new calibration information after updating.

Preferably, when the image processing means performs the image corrections on the recorded data following recording of the radiation image of the subject, previous calibration information which was used in the image corrections having previously been done and which is stored in the information storage means is used unchanged.

Preferably, when the previous calibration information which was used in the image corrections having previously been done and which is stored in the information storage means is used unchanged to provide a provisional display in recording the radiation image of the subject in the normal mode, the system issues a command for performing the calibration as soon as possible to acquire the new calibration information.

Preferably, at a point in time when a second recorded image having undergone the image corrections based on the new calibration information after updating is obtained, the second recorded image replaces a first recorded image having undergone the image corrections using unchanged the previous calibration information which was used in the image corrections having previously been done and which is stored in the information storage means.

The radiation image recording system preferably has a function of informing an operator of whether the recording mode currently applied is the normal mode or the emergency mode.

According to the present invention having the above-described structural design, there is obtained a beneficial effect of realizing a radiation image recording system that takes into account the service life of a solid-state radiation detector (FPD) and which yet can cope with emergencies in an advantageous way.

There is obtained an additional beneficial effect of providing a novel radiation image recording system that is adapted to be capable of coping with emergencies in a special mode (emergency mode).

More specifically, even if it is in an unstable state (namely, in the emergency mode), the radiation image recording system enables the operator to execute a minimum of recording procedure and know whether it is in the normal mode or in the emergency mode.

### BRIEF DESCRIPTION OF THE DRAWINGS

FIG. 1 is a block diagram showing in concept an exemplary radiation image recording apparatus according to an embodiment of the present invention; and

FIG. 2 is a flowchart for illustrating an example of the operation of the radiation image recording apparatus shown in FIG. 1.

### DETAILED DESCRIPTION OF THE INVENTION

The radiation image recording system according to the present invention is described below in detail based on the preferred embodiment shown in the accompanying drawings.

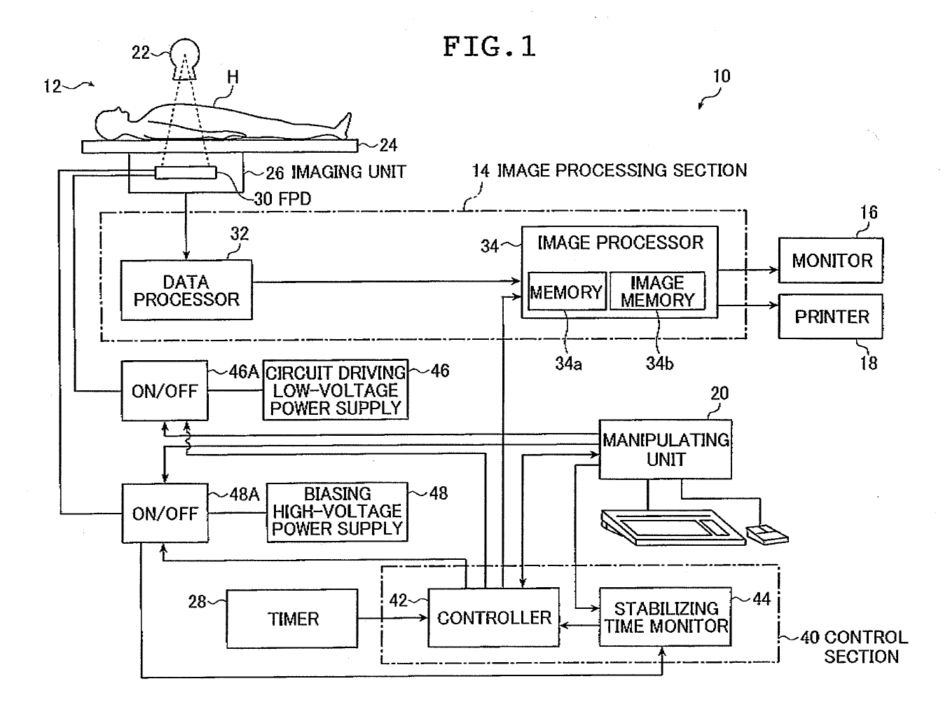

FIG. 1 shows in concept an exemplary radiation image recording apparatus that may be used in the radiation image recording system according to the present invention.

The radiation image recording apparatus (hereinafter referred to simply as the “imaging apparatus”) indicated by 10 in FIG. 1 is one that records a radiation image (diagnostic image) of a subject H (object); it comprises an imaging section 12 that records a radiation image, an image processing section 14 that processes the radiation image taken with the imaging section 12, a monitor 16, a printer 18, and a control section 40 that is a characteristic feature of the embodiment under consideration and which performs overall control including the capability of setting the recording mode.

The imaging section 12 is a site for recording a radiation image of the subject H and comprises a radiation source 22, an imaging platform 24, and an imaging unit 26.

The radiation source 22 is a common radiation source that may be installed in a variety of radiation image recording apparatuses. The imaging platform 24 is also a common imaging platform that may be employed with a variety of radiation image recording apparatuses. It should be noted that the imaging apparatus 10 may optionally be equipped with a means of moving the radiation source 22, a means of ascending or descending the imaging platform 24, a means of moving it in the horizontal direction, a means of tilting the imaging platform 24, and the like.

The imaging unit 26 records a radiation image on a solid-state radiation detector (hereinafter also referred to as an “FPD”) 30.

The imaging apparatus 10, like a common radiation image recording apparatus, receives the radiation on the receiving surface of the FPD 30 as it has been emitted from the radiation source 22 and passed through the subject H and performs photoelectric conversion on that radiation so as to record the radiation image of the subject H.

In the present invention, the FPD 30 is a common FPD (flat panel detector) employed in radiation image recording apparatuses.

In the present invention, the FPD 30 may be one of the so-called direct type which uses a photoconductive film, typically made of amorphous selenium, and a TFT (thin film transistor) or the like and in which electron-hole pairs (e-h pairs) that have been emitted from the photoconductive film in response to the incidence of a radiation are collected and read as an electrical signal by means of the TFT, or it may be one of the so-called indirect type which uses a scintillator layer, typically made of CsI:Tl, as a phosphor that emits light (fluoresces) in response to the incidence of a radiation, a photodiode and a TFT or the like and in which the luminescence from the scintillator layer in response to the incidence of a radiation is subjected to photoelectric conversion with the photodiode and read as an electrical signal by means of the TFT.

In addition to the FPD 30, the imaging unit 26 may of course be equipped with a grid as a shield from the scattering radiation that might be incident on the FPD 30, a means of moving the grid, or various other members that are used in known radiation image recording apparatuses.

An output signal for the radiation image recorded with the imaging unit 26 (FPD 30) is delivered to the image processing section 14.

The image processing section 14 processes the output signal from the FPD 30 to create image data that is associated with the display to be presented by the monitor 16, as well as image data that is associated with a print output from the printer 18, and even with the output of a radiation image (data) that is delivered over a network or on a recording medium. In the illustrated imaging apparatus 10, the image processing section 14 comprises a data processor 32 and an image processor 34.

The image processing section 14 may typically be composed of one or more computers or workstations and it may have a keyboard, a mouse and the like for enabling a variety of manipulations, entering a variety of instructions, and the like.

The data processor 32 performs A/D conversion, log conversion and other processes on the output signal from the FPD 30 such that it is converted to image data for the radiation image to be output.

The image processor 34 contains a memory 34a storing image correction data (calibration data) and image processing parameters for performing various image processing operations and an image memory 34b storing recorded radiation image data (hereinafter also referred to as “recorded data”). The image processor 34 uses the image processing parameters stored in the memory 34a to subject the radiation image processed in the data processor 32 (image data thereof) to specified image processing operations to create a radiation image that is suitable for image display on the monitor 16, output of a print (hard copy) from the printer 18 or output to a network or a on a recording medium. The memory 34a storing calibration data and the image memory 34b storing recorded data may be physically different memories or different memory regions of a single memory. The present invention is not limited to the case where these memories are incorporated into the image processor 34, and the memories may be incorporated into any component in the imaging apparatus 10 or disposed outside the apparatus and connected to a specified component for their use. For example, these may be memories disposed within the image processing section 14, or memories disposed within the control section 40 or controller 42, or external memories connected to these components.

It should be noted here that the image processing to be carried out by the image processor 34 is capable of all image processing operations that are performed in various radiation image recording apparatuses and they include, for example, image corrections (corrections of radiation image data with calibration data) including correction of pixel defects, construction of defect maps for the pixel defect correction, offset correction using a dark image, gain correction using an image produced by specified uniform exposure and shading correction, as well as gradation correction, density correction, and data conversion which involves converting image data to data for monitor display or print output.

Described next is the control section 40 that is a characteristic feature of the embodiment under consideration and which performs overall control including the capability of setting the recording mode.

The control section 40 comprises a controller 42 composed of a computer or a workstation and a stabilizing time monitor 44 to be described later.

The controller 42 is connected to a manipulating unit 20 and a timer 28 and it has such a feature that in response to a command the operator enters from the manipulating unit 20 or a signal from the timer 28, it controls ON/OFF of a circuit driving low-voltage power supply 46 and a biasing high-voltage power supply 48.

The biasing high-voltage power supply 48 is the one to apply a high voltage (e.g., 200 V) to the FPD 30 and is used because of its high power consumption in the form in which the power supply 48 is turned on every day at the start-up of the imaging apparatus 10, for example at the fixed time every morning, and is turned off every day at the end of its use, for example at the fixed time every evening. On the other hand, the circuit driving low-voltage power supply 46 is a power supply for use in electronic circuits and is also very often used in the form of being turned on or off as in the biasing high-voltage power supply 48. Since the voltage applied is as low as several volts and the power consumption is not so high, the circuit driving low-voltage power supply 46 is also very often used, as in the case where it is used to drive a cooling fan for an electronic circuit, in the form in which the power supply 46 is always turned on irrespective of whether the biasing high-voltage power supply 48 is turned on or off. It may also be turned on or off irrespective of whether the power supply 48 is turned on or off.

The timer 28 is provided to automatically turn on/off and particularly turn on the circuit driving low-voltage power supply 46 and the biasing high-voltage power supply 48 and in particular the biasing high-voltage power supply 48 in hospitals or other facilities at the fixed time every day.

The controller 42 is also connected to the stabilizing time monitor 44 which checks the time elapsed since the biasing high-voltage power supply 48 was turned on. The controller 42 further has the capability of controlling the overall operation of the imaging apparatus 10 according to the embodiment under consideration, for example, controlling the imaging operation and the operation for calibration (the operation for acquiring calibration data).

The circuit driving low-voltage power supply 46 supplies a circuit driving low voltage to the FPD 30 via a switch means 46A, and the biasing high-voltage power supply 48 supplies a biasing high voltage to the FPD 30 via a switch means 48A.

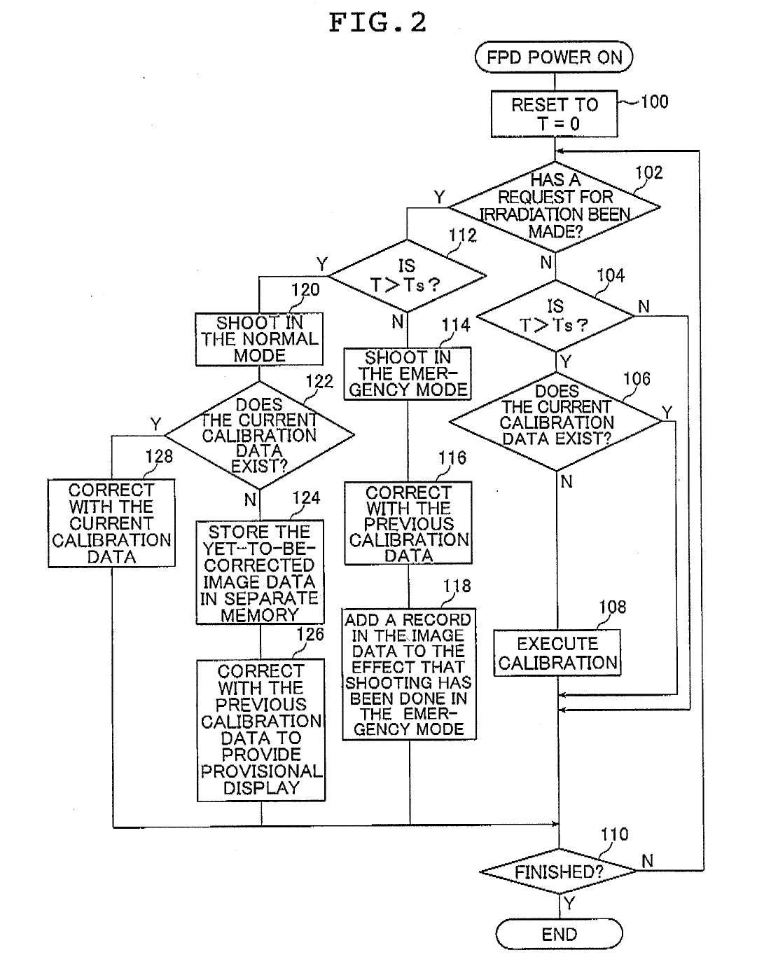

The stabilizing time monitor 44 has a built-in timer (not shown); when the controller 42 turns on the biasing high-voltage power supply 48 in response to a command entered with the manipulating unit 20 or a signal from the timer 28, the stabilizing time monitor 44 actuates the built-in timer in response to a signal sent from the controller 42 to count the time elapsed since the biasing high-voltage power supply 48 was turned on. The method of using the result of this counting will be described later based on the operational flowchart shown in FIG. 2.

As described above, the imaging apparatus 10 according to the embodiment under consideration comprises the stabilizing time monitor 44 and the controller 42 having the novel control capability.

In the common radiation image recording system, at the point in time when the FPD 30 has stabilized after the lapse of a specified time since the biasing high-voltage power supply 48 to the FPD 30 was turned on, specified calibrating operations including calibration of the FPD 30 and acquisition of calibration data for correcting a radiation image from the FPD 30 are performed. In contrast, the radiation image recording system of the present invention which uses the imaging apparatus 10 having the structural design described above performs the following characteristic operation by the controller 42 depending upon the time that has lapsed since the biasing high-voltage power supply 48 to the FPD 30 was turned on and which is counted by the stabilizing time monitor 44.

As FIG. 2 shows, the controller 42, upon turning on the FPD power supply (biasing high-voltage power supply 48), commands the stabilizing time monitor 44 to count the elapsed time (T) since the biasing high-voltage power supply 48 was turned on. The process of this counting starts with resetting T to zero (step 100) and then checking to see if any request for irradiation (with X-rays for recording) is made (step 102).

If no request for irradiation has been made within a specified time Ts (this is the time it takes for stabilizing the FPD 30 by means of the FPD power supply) (N in step 102 and Y in step 104), the FPD 30 stabilizes and the process goes to a calibration stage so that the imaging apparatus 10 will be used in the regular way (normal method of use, which is hereinafter referred to as the normal mode).

The calibration stage starts with checking if the current calibration data (calibration data acquired at the point in time when the FPD 30 has stabilized; in other words, calibration data usable in the normal mode) exists in a specified storage means, in the memory 34a in the embodiment shown in FIG. 1 (checking the status of calibration data stored in the memory 34a) (step 106). If it does (Y in step 106), the process associated with start-up of the imaging apparatus 10 ends, then whether or not the imaging apparatus 10 is continuously used, that is, use of the apparatus is finished (imaging is continued) is determined (step 110). If the imaging apparatus 10 is continuously used (N in step 110), the process returns to step 102 to monitor whether or not there is a request for irradiation, and if the imaging apparatus 10 is not continuously used (Y in step 110), use of the imaging apparatus 10 is finished.

Also in the case where the elapsed time T does not reach the specified time Ts, the process proceeds to step 110, where it is determined as above whether or not use of the apparatus is finished and the process is carried out in the same manner.

If, on the other hand, the check in step 106 shows that the current calibration data does not exist (N in step 106), the imaging apparatus 10, more specifically the FPD 30 is newly calibrated to acquire calibration data, that is, calibration data for correcting a radiation image from the FPD 30 (step 108).

Calibration, that is, calibration of the imaging apparatus 10, more specifically the FPD 30 is executed in such a manner that a first detection image (dark image) recorded in the FPD 30 in an imaging environment without laying a subject H on the imaging platform 24 or irradiating the FPD 30 with radiation from the radiation source 22 as well as a second detection image recorded in the FPD 30 by emitting specified uniform radiation from the radiation source 22 toward the FPD 30 without laying a subject H on the imaging platform 24 in the same manner as above are acquired and calibration data used, for example to perform offset correction, gain correction, shading correction and defect correction is acquired from the previously obtained first and second detection images.

The thus acquired calibration data is then stored as the current calibration data in the memory 34a within the image processor 34 of the image processing section 14.

Then, the process proceeds to step 110, where it is determined as above whether or not the imaging apparatus 10 is continuously used, and the process is carried out in the same manner. If the imaging apparatus 10 is continuously used, as will be described later, the image recorded in the normal mode, namely the radiation image detected by the FPD 30 (step 120) is processed in the data processor 32 of the image processing section 14 in the imaging apparatus 10 before being subjected in the image processor 34 to corrections such as offset correction, gain correction, shading correction and defect correction with the current calibration data read out from the image memory 34a (step 128).

If the check in step 102 shows that a request for irradiation has been made within the specified time Ts (Y in step 102), step 112 checks to see if the elapsed time T since the biasing high-voltage power supply 48 was turned on has reached the specified time Ts. If the elapsed time T exceeds the specified time Ts (Y in step 112), this means the FPD 30 has stabilized, so recording will be done in the above-mentioned normal mode (step 120).

As in the aforementioned step 106, a check is then made to see if the current calibration data exists in the specified storage means (memory 34a) (step 122) and if it does (Y in step 122), the current calibration data is used to correct the data of the radiation image recorded with the imaging apparatus 10 (step 128) (this data being hereinafter also referred to as “recorded data”); the data corrected after being recorded in the current imaging operation is thus obtained to end one imaging operation (step 110). Thereafter, whether or not use of the apparatus is finished is determined in step 110 in the same manner. If it is not, the process returns to step 102, and if it is, use of the apparatus 10 is finished.

If the check in step 122 shows that the current calibration data does not exist in the specified storage means (memory 34a) (N in step 122), the data of the radiation image recorded in step 120 (i.e., the image data before correction) is stored in a specified separate memory region, for example, in the built-in image memory 34b of the image processor 34 (step 124) and the previous calibration data stored in the memory 34a is used to correct that image, which is displayed as a provisional image (provisional display) (step 126). In this case, the process once ends here (step 110). Thereafter, whether or not use of the apparatus is finished is determined in step 110 in the same manner. If it is not, the process returns to step 102, and if it is, use of the apparatus 10 is finished.

If, on the other hand, the check in step 112 shows that the elapsed time T since the biasing high-voltage power supply 48 was turned on has not reached the specified time Ts (N in step 112), this means the FPD 30 is yet to stabilize, so recording will be done in the above-mentioned emergency mode (step 114).

Since this is the case where the FPD 30 has not yet stabilized, the previous calibration data stored in the memory 34a is used to correct the recorded image (step 116) and, in addition, the image data is tagged with a record of information to the effect that the recording was in the emergency mode (step 118). In this case, this process once ends here (step 110). Thereafter, whether or not use of the apparatus is finished is determined in step 110 in the same manner. If it is not, the process returns to step 102, and if it is, use of the apparatus 10 is finished.

In a preferred embodiment, the controller 42 notifies the manipulating unit 20 to the effect that the imaging apparatus 10 in the above-described step 114 is in the state for “recording in the emergency mode” or that the imaging apparatus 10 in step 120 is in the state for “recording in the normal mode,” with this notice being typically displayed on a monitor or the like in the manipulating unit 20 (in such a form as tag information to the image).

If a display is to be made to the effect that the imaging apparatus 10 is in the state for “recording in the emergency mode,” it is preferred to make an additional display alerting the operator “not to continue the recording in this mode for the subsequent period.”

The method of notifying the operator (user) that the imaging apparatus 10 is in the state for “recording in the emergency mode” is not limited to the display-based technique mentioned above and another method that can be used with advantage is by changing the shot sound to be heard during recording.

The imaging apparatus 10 according to the embodiment described above has the advantage that recording in the emergency mode which is to be performed in the case where the elapsed time T since the biasing high-voltage power supply 48 was turned on has not reached the specified time Ts can be initiated right after starting up the imaging apparatus 10 and there is no need to perform the heretofore required calibration step. In this case, in order to perform post-recording correction of image quality, the calibration data that was acquired and stored at the previous start-up shall be used unchanged.

To be more specific, the FPD is yet to stabilize in the emergency mode, so the radiation image recording apparatus of the present invention is adapted to operate in such a way that rapidity is given priority at the expense of some reduction in image quality. Further in addition, the image data acquired in this case is so adapted that in order to enable the operator (user) to be aware that the recording was in the emergency mode, a notice to that effect is recorded in header information or the like for display together with the image.

In the case of recording in the normal mode, it is possible to use the calibration data acquired when the FPD was in a stable state. Therefore, if the FPD 30 has stabilized after the imaging apparatus 10 was started up but recording was done without acquiring any calibration data (current calibration data) (N in step 122 of FIG. 2), the calibration data for the previous use of the apparatus (previous calibration data) is employed for a provisional display (step 126) but, at the same time, the operator (user) is urged to recognize the need for performing calibration and the image (initial image) that is yet to be corrected on the basis of the previous calibration data is stored separately in the specified storage means (image memory 34a) (step 124).

In this case, the process proceeds from step 126 for provisional display to step 110, where use of the apparatus is not finished (N in step 110). Then, the process returns to step 102 and proceeds through step 104 (Y) to step 106, from which the process further proceeds to step 108 because the current calibration data does not exist (N in step 106). As described above, calibration is executed in step 108 to acquire the current calibration data, which is then stored in the memory 34a.

The thus acquired calibration data may be used to correct the initial image, with the resulting image being overwritten and saved. It is not always necessary to acquire calibration data for all of the aforementioned four corrections after recording has been made in the normal mode without acquiring the current calibration data. In principle, the calibration data to be used may be limited to the data for use in offset correction and defect correction that can be acquired from a dark image alone.

Regarding the defect correction mentioned above, the imaging apparatus using the FPD has the disadvantage that there is no preventing the number of pixel defects on the FPD from increasing over time and in order to perform the appropriate reading of the recorded image and the like, it is important to grasp the state of the pixel defects. However, the pixel defects on the FPD are not always uniform throughout its surface but they are localized in most cases.

It then follows that by performing appropriate correction of pixel defects, an appropriate radiation image can be obtained in most cases.

The description of the operation of the radiation image recording system according to the present invention is further supplemented below. Turning off the circuit driving low voltage and the biasing high voltage as in power down at the end of the day's work is not the only case that is contemplated in the present invention. The radiation image recording system according to the present invention may be re-started with the biasing high voltage being kept on, as exemplified by the case where the power supply to a computer composing the controller and/or manipulating unit or a console for operating the controller and/or manipulating unit is turned off temporarily (for rebooting the computer, for example); in this case, the FPD is in a stable state, so the system is maintained to be capable of recording in the normal mode. It, in this case, some calibration data already exists that was acquired when the FPD was in a stable state, it may be used unchanged.

In another preferred embodiment, the aforementioned time Ts (the time it takes for the FPD to be stabilized by means of the FPD power supply) may be set to be variable depending upon the elapsed time since the previous high-voltage power application was discontinued.

The foregoing embodiment assumes the case where the stabilizing time monitor 44 is provided within the control section 40 but this is just one example and the stabilizing time monitor 44 may be a built-in component of the imaging unit 26, for example the FPD 30. In this alternative case, the power supply to the imaging apparatus 10 may be interrupted temporarily (as in the case of upgrading the version of the built-in software) without compromising the need to give priority to the counting by the stabilizing time monitor 44 in the FPD 30.

In the structural design of the foregoing embodiment, the stabilizing time monitor checks the elapsed time since the start of power application to the solid-state radiation detector but this is not the sole case of the present invention and it may be so adapted that it also checks the elapsed time since the end of the previous power application; this alternative embodiment enables more rationale switching from the emergency mode to the normal mode and vice versa.

This is in order to ensure that even in the case where there is no particular need to wait for a certain amount of time to lapse since the start of power application, such as where power application is started immediately after the end of power application to the solid-state radiation detector, one can cope with the situation in a rationale way.

Another effective design is to provide a feature by which the operator (user) is notified just how soon the radiation image recording system of the present invention that is in the state for “recording in the emergency mode” will be brought to the state for “recording in the normal mode.”

A specific method that can be adopted advantageously to provide this feature is by displaying a countdown of the time that lapses until the state for “recording in the normal mode” is reached or by displaying a message reading XX MINUTES TO GO before the state for “recording in the normal mode” is reached.

As described above, the present invention is capable of checking the power supply of the solid-state radiation detector with the stabilizing time monitor to see if the solid-state radiation detector is in a stable state, setting an appropriate recording mode, preferably normal mode or emergency mode based on the result of checking, and notifying the manipulating unit or console of the thus set mode.

Therefore, the present invention is capable of minimum recording operation even if the solid-state radiation detector is in an unstable state (i.e., emergency mode), whereby it can be seen if the radiation image recording system is in any recording mode, that is, normal mode or emergency mode.

The present invention can determine the calibration information (data) to be used in the image corrections depending on whether the recording mode applied is the normal mode or emergency mode.

Accordingly, image processing based on the optimal calibration information (data) can be carried out in accordance with the applications of the respective recording modes.

While the radiation image recording system of the present invention has been described above in detail, it should be understood that the present invention is by no means limited to the foregoing embodiment and that various improvements and modifications can of course be made without departing from the scope and spirit of the present invention.

What is claimed is:

1. A radiation image recording system comprising:
a radiation source which irradiates a subject with radiation to record a radiation image of said subject;
a solid-state radiation detector which detects the radiation emitted from said radiation source;
information storage means which stores calibration information of said radiation image detected by said solid-state radiation detector;
image processing means which subjects recorded data of said radiation image of said subject as detected by said solid-state radiation detector to image corrections based on said calibration information stored in said information storage means;
stabilizing time monitor means which monitors time elapsed since start of power application to said solid-state radiation detector; and
control means which sets a recording mode of said radiation image of said subject based on information on the elapsed time as obtained from said stabilizing time monitor means,
wherein, when said information on the elapsed time indicates that a specified stabilizing time has elapsed, said control means causes said solid-state radiation detector to undergo a calibration to acquire new calibration information and causes said information storage means to store the acquired new calibration information to update said stored calibration information to said new calibration information.

2. The radiation image recording system according to claim 1, wherein said control means further confirms a status of said calibration information stored in said information storage means based on said recording mode.

3. The radiation image recording system according to claim 2, wherein said control means further causes said image processing means to perform said image corrections on said recorded data based on said calibration information stored in said information storage means in accordance with said recording mode being set and the confirmed status of said calibration information.

4. The radiation image recording system according to claim 2, wherein said control means further determines whether or not said calibration information stored in said information storage means is to be updated, and when said calibration information is determined to be updated, said control means causes said calibration to be executed to acquire the new calibration information to be stored in said information storage means as said calibration information, and causes said image processing means to perform said image corrections on said recorded data based on the acquired new calibration information after the recorded data has been acquired or while the recorded data is being acquired beforehand.

5. The radiation image recording system according to claim 1,
wherein said radiation image recording system has said recording mode selected from an emergency mode that corresponds to a case where said solid-state radiation detector is not in a stable state and a normal mode that corresponds to a case where said solid-state radiation detector is in a stable state, and
wherein said control means sets said emergency mode as said recording mode when said information on the elapsed time from said stabilizing time monitor means is information indicating that said specified stabilizing time necessary to bring said solid-state radiation detector into the stable state has not elapsed, and sets said normal mode as said recording mode when said information on the elapsed time is information indicating that said specified stabilizing time has elapsed.

6. The radiation image recording system according to claim 5, wherein said control means enables said radiation image of said subject to be recorded in said emergency mode without causing said calibration to be executed.

7. The radiation image recording system according to claim 5, wherein said radiation image of said subject to be output is tagged with information to effect that said radiation image is an image recorded in said emergency mode which is not subjected to said image corrections based on the new calibration information after updating.

8. The radiation image recording system according to claim 5, wherein, when said image processing means performs said image corrections on said recorded data following recording of said radiation image of said subject, previous calibration information which was used in said image corrections having previously been done and which is stored in said information storage means is used unchanged.

9. The radiation image recording system according to claim 5, wherein, when said previous calibration information which was used in said image corrections having previously been done and which is stored in said information storage means is used unchanged to provide a provisional display in recording said radiation image of said subject in said normal mode, the system issues a command for performing said calibration as soon as possible to acquire said new calibration information.

10. The radiation image recording system according to claim 9, wherein at a point in time when a second recorded image having undergone said image corrections based on said new calibration information after updating is obtained, said second recorded image replaces a first recorded image having undergone said image corrections using unchanged said previous calibration information which was used in said image corrections having previously been done and which is stored in said information storage means.

11. The radiation image recording system according to claim 5, which has a function of informing an operator of whether said recording mode currently applied is said normal mode or said emergency mode.
